(19) United States
(12) Patent Application Publication
(10) Pub. No.: US 2004/0110656 A1
(43) Pub. Date: Jun. 10, 2004

(54) Detergent compositions

(75) Inventors: Siobhan Casey, Bebington (GB); Marie Anne Kennedy, Upton (GB); Philip Ronald Moore, Bebington (GB)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 10/726,739

(22) Filed: Dec. 3, 2003

(30) Foreign Application Priority Data
Dec. 7, 2002 (GB) 0228584.9

(51) Int. Cl. C11D 17/00

(52) U.S. Cl. 510/424; 510/426; 510/447

(57) ABSTRACT

A solid porous surfactant body of low density, for example, a tablet, comprises a high level of surfactant: at least 60 wt % and preferably at least 75 wt %. Preferably a high level of anionic surfactant is present. Inorganic salts are preferably absent, or present only in small quantities. The body is typically in the form of an assembly of solid surfactant particles, for example, flakes, bonded together by means of heat and/or a binder.

### TECHNICAL FIELD

The present invention relates to a solid surfactant body suitable for use as, or in, a laundry detergent composition.

### BACKGROUND AND PRIOR ART

Traditionally laundry detergent powders have contained, as well as the surfactant required for cleaning, one or more inorganic builder salts which aid the wash process by binding calcium in the wash liquor but which also play a major role in the structure of the powder itself. Most of the anionic and nonionic surfactants conventionally used in laundry detergents are supplied as liquids, pastes or waxy solids, and inorganic salts are required to carry the more mobile ingredients and to provide powder structure.

Accordingly, most laundry detergent powders, whether of high or low bulk density, contain a “base powder” consisting of composite granules of surfactant and builder, prepared either by spray-drying a slurry in a spray-drying tower, or by mixing and granulation (non-tower processing) in a high-shear mixer/granulator. Other lesser ingredients that are sufficiently robust to survive these processes may also be contained in the base granules, while more sensitive ingredients such as bleaches and enzymes are subsequently admixed (“postdosed”).

Powders normally contain substantial levels of inorganic salts, not only builders such as zeolites or phosphates but, for example, sodium carbonate to provide alkalinity, sodium sulphate as a filler and to provide sufficient ionic strength in the wash, and sodium silicate for alkalinity, powder structure and anticorrosion properties. Bleaching salts such as sodium percarbonate and sodium perborate may also be present.

The laundry detergent tablets that have recently become popular are generally of similar composition and prepared by similar processes, followed by a compaction step. Binders may also be required to hold the tablets together. The resulting tablets are of high bulk density—generally at least 1000 g/litre—and low porosity, and may require disintegrants to enable them to break up sufficiently fast and disperse sufficiently thoroughly in the wash.

In recent years there has been a move in the detergents industry to use lower levels of sodium sulphate in laundry powders. Further reduction of the inorganic content of laundry detergents would be highly desirable to reduce the load on waste systems. Elimination of insoluble ingredients such as zeolite reduces the possibility of solid residues being deposited on washed items. Simplification of laundry detergent compositions and of the processes for making them is also a valuable goal.

The present inventors have identified a possible route to the preparation of solid detergent compositions with reduced or no inorganic content, having good detergency across a range of wash conditions and excellent dispersion and dissolution properties.

### DEFINITION OF THE INVENTION

The present invention provides a solid porous surfactant body comprising at least 60 wt % surfactant and having a density not exceeding 700 g/litre.

The present invention further provides a process for the preparation of a solid porous surfactant body as defined above, which comprises the steps of

(i) converting an assembly of surfactant particles to a cohesive state by heating and/or mixing with binder,

(ii) allowing the resulting cohesive assembly of particles to set to form a solid body.

The invention further provides a particulate detergent composition comprising a solid porous surfactant body as defined above in admixture or conjunction with one or more other solid detergent ingredients.

### DETAILED DESCRIPTION OF THE INVENTION

The solid surfactant body of the invention is characterised by its high surfactant content and its low density.

The density does not exceed 700 g/litre, and preferably does not exceed 600 g/litre.

The lower the density, the higher the porosity, and the faster the dissolution.

Surfactant Content of the Solid Surfactant Body

The solid surfactant body may contain a minor proportion of materials other than surfactants. However, the total surfactant content is at least 60 wt %, preferably 75 wt %, more preferably at least 90 wt %.

Preferably the solid surfactant body comprises at least 50 wt %, more preferably at least 70 wt %, of anionic sulphonate and/or sulphate surfactant. Especially preferred surfactants are alkylbenzene sulphonate and/or alkyl sulphate.

Other anionic surfactants that may be present include alkyl ether sulphates; olefin sulphonates; alkyl xylene sulphonates; dialkyl sulphosuccinates; and fatty acid ester sulphonates. Sodium salts are generally preferred.

The detergency profile of the solid surfactant body across a range of wash conditions may be optimised by using combinations of surfactants. Where the principal surfactant is a calcium-intolerant material such as linear alkylbenzene sulphonate, advantageously one or more calcium-tolerant cosurfactants may be present.

If desired, nonionic surfactant may also be present. Nonionic surfactants that may be used include the primary and secondary alcohol ethoxylates, especially the C₈-C₂₀ aliphatic alcohols ethoxylated with an average of from 1 to 20 moles of ethylene oxide per mole of alcohol, and more especially the C₁₀-C₁₅ primary and secondary aliphatic alcohols ethoxylated with an average of from 1 to 10 moles of ethylene oxide per mole of alcohol. Non-ethoxylated nonionic surfactants include alkylpolyglycosides, glycerol monoethers, and polyhydroxyamides (glucamide).

According to one preferred embodiment of the invention, there is present an ethoxylated alcohol nonionic surfactant of the general formula I

R—(—O—CH₂—CH₂)ₙ—OH (I)

wherein R is a hydrocarbyl chain having from 8 to 16 carbon atoms, and the average degree of ethoxylation n is from 20 to 50.

More preferably, the ethoxylated alcohol nonionic surfactant has a hydrocarbyl chain R containing from 10 to 16 carbon atoms and an average degree of ethoxylation n of from 25 to 40.

The solid porous surfactant body of the invention may suitably contain from 1 to 20 wt %, preferably from 5 to 15 wt %, of the ethoxylated nonionic surfactant.

The ratio of anionic surfactant to ethoxylated nonionic surfactant may suitably be from 1:1 to 15:1, more preferably from 1:1 to 10:1, and most preferably from 2:1 to 6:1.

Cationic surfactants that may be used include quaternary ammonium salts of the general formula R₁R₂R₃R₄N⁺ X⁻ wherein the R groups are long or short hydrocarbyl chains, typically alkyl, hydroxyalkyl or ethoxylated alkyl groups, and X is a solubilising anion (for example, compounds in which R₁ is a C₈-C₂₂ alkyl group, preferably a C₈-C₁₀ or C₁₂-C₁₄ alkyl group, R₂ is a methyl group, and R₃ and R₄, which may be the same or different, are methyl or hydroxyethyl groups); and cationic esters (for example, choline esters).

The list of surfactants is not intended to be exhaustive and, subject to compatibility and processing restraints, in principle any surfactant suitable for incorporation in particulate laundry detergent compositions may be used.

The solid porous surfactant body according to the invention may be substantially free of fatty acid soap.

Inorganic Salts and Builders

Preferably, the solid surfactant body of the invention contains not more than 40 wt %, preferably not more than 20 wt %, and most preferably not more than 10 wt %, of inorganic salts.

According to one preferred embodiment of the invention, it is substantially free of inorganic salts other than bleaching salts.

Zeolite or phosphate builder salts may be present, although according to an especially preferred embodiment of the invention inorganic builder salts are absent.

Organic builders that may be present include polycarboxylate polymers such as polyacrylates and acrylic/maleic copolymers; monomeric polycarboxylates such as citrates, gluconates, oxydisuccinates, glycerol mono-, di- and trisuccinates, carboxymethyloxysuccinates, carboxymethyloxymalonates, dipicolinates, hydroxyethyliminodiacetates, alkyl- and alkenylmalonates and succinates; and sulphonated fatty acid salts.

Structure of the Solid Surfactant Body

According to the invention, the low density and corresponding porosity are achieved by the structure of the surfactant body, which is an assembly of particles held together by inter-particle bonding. The bonding may be generated by the incorporation of a low level of binder and/or, when the melting characteristics of the surfactant permit, by controlled heating.

The size and shape of the particles are important in order to achieve optimum properties.

Preferably the particle size is greater than 1 micrometre and does not exceed 1500 micrometres.

More preferably, the particle size is within the range of from 200 to 1000 micrometres.

It appears to be advantageous for the particles to be of irregular shape. Flakes are especially preferred.

As previously mentioned, a binder may present, suitably in an amount of from 0.1 to 15 wt %. The binder may be, for example, a non-surfactant polymer such as polyethylene glycol.

Alternatively or additionally, a nonionic surfactant present in the solid porous body may also act as a binder.

Preparation of the Solid Surfactant Body

A preferred process for the preparation of the solid porous surfactant body comprises the steps of:

(i) converting an assembly of surfactant particles to a cohesive state by heating and/or mixing with binder,

(ii) allowing the resulting cohesive assembly of particles to set to form a solid body.

Step (ii) may be carried out in a mould whereby a body of any desired size or shape may be created.

For example, a body of similar size to a commercially available laundry detergent tablet may be produced.

Detergent Compositions and Ingredients

The solid surfactant may be used in its own right as a laundry detergent composition, for example as a tablet, or it may be used together with other components in a more complex product.

The invention therefore further provides a particulate detergent composition comprising a solid porous surfactant body as claimed in any preceding claim in admixture or conjunction with one or more other solid detergent ingredients.

Detergent compositions according to the invention may suitably contain a bleach system. Preferably this will include a peroxy bleach compound, for example, an inorganic persalt or an organic peroxyacid, capable of yielding hydrogen peroxide in aqueous solution.

Preferred inorganic persalts are sodium perborate monohydrate and tetrahydrate, and sodium percarbonate, the latter being especially preferred. The sodium percarbonate may have a protective coating against destabilisation by moisture. The peroxy bleach compound is suitably present in an amount of from 5 to 35 wt %, preferably from 10 to 25 wt %.

The peroxy bleach compound may be used in conjunction with a bleach activator (bleach precursor) to improve bleaching action at low wash temperatures. The bleach precursor is suitably present in an amount of from 1 to 8 wt %, preferably from 2 to 5 wt %. Preferred bleach precursors are peroxycarboxylic acid precursors, more especially peracetic acid precursors and peroxybenzoic acid precursors; and peroxycarbonic acid precursors. An especially preferred bleach precursor suitable for use in the present invention is N,N,N′,N′-tetracetyl ethylenediamine (TAED). A bleach stabiliser (heavy metal sequestrant) may also be present. Suitable bleach stabilisers include ethylenediamine tetraacetate (EDTA), diethylenetriamine pentaacetate (DTPA), ethylenediamine disuccinate (EDDS), and the polyphosphonates such as the Dequests (Trade Mark), ethylenediamine tetramethylene phosphonate (EDTMP) and diethylenetriamine pentamethylene phosphate (DETPMP).

Other materials that may be present in detergent compositions of the invention include antiredeposition agents such as cellulosic polymers; soil release agents; anti-dye-transfer agents; foam boosters or foam controllers as appropriate; fluorescers; enzymes (for example, proteases, lipases, amylases, cellulases); dyes; coloured speckles; perfumes; and fabric conditioning compounds.

Subject to compatibility and processing restraints, some of these materials may be incorporated in the solid surfactant body itself, while others are more suitably present as separate postdosed ingredients.

### EXAMPLES

The invention is further illustrated by the following non-limiting Examples in which parts and percentages are by weight unless otherwise stated.

### Example 1

Preparation of Tablet of Linear Alkylbenzene Sulphonate (LAS)

The raw materials used were as follows:

| | |
|---|---|
| Sodium linear alkylbenzene sulphonate flakes | 7.00 g |
| (Nansa (Trade Mark) 90HF | |
| ex Huntsman Surface Sciences) | |
| Polyethylene glycol | 0.77 g |
| (PEG 6000, molecular weight 6000, | |
| ex Fisher Chemicals) | |

The LAS flakes were mixed with the polyethylene glycol and heated in a Sharp Carousel convection oven at 160° C. to a temperature of 60° C.

The resulting mass was poured into a mould having dimensions of 4 cm by 2 cm by 2 cm (volume 16 cm³) and allowed to set at ambient temperature for 30 minutes.

The resulting tablet having a mass of 7.77 g and a volume of 16 cm³ had a density of 485 g/litre. Its surfactant content of 7.0 g is comparable to that of a commercial half-dose laundry detergent tablet.

Dissolution Times

The dissolution times of the tablet of Example 1 and a commercially available half-wash laundry detergent tablet (Comparative Example A) were compared.

The tablet of Comparative Example A had the following formulation:

| | wt % |
|---|---|
| Na LAS | 10.69 |
| Nonionic surfactants (C₁₃-C₁₅ 7EO and 3EO) | 4.73 |
| Sodium tripolyphosphate | 16.60 |
| Sodium silicate | 3.92 |
| Sodium carbonate | 1.47 |
| Granular sodium tripolyphosphate | 31.57 |
| Sodium percarbonate | 14.70 |
| Tetraacetyl ethylenediamine | 3.28 |
| Antifoam granule (silicone oil/sodium carbonate) | 3.12 |
| Soap, enzymes, sequestrant, fluorescer, polymers, | to |
| perfume, salts, moisture | 100.00 |

Dissolution times were compared using a conductivity method. A 5-litre beaker was filled with 3 litres of deionised water and heated to 35° C. The tablets were placed in a coarse mesh wire cage attached to a stirrer which was rotated at 500 revs/minute.

The conductivity of the solution was measured using a conductivity probe fixed near to the wall of the beaker. The conductivity was recorded on a chart recorder that tracked the change in conductivity over time.

The t₉₀ values (the time for 90 wt % dissolution to take place) of the tablets were as shown below.

| | t₉₀ (seconds) |
|---|---|
| Example 1 | 18 |
| Comparative Example A | 156 |

### Example 2

Preparation of Tablet Containing LAS and Nonionic Surfactant

Using the method of Example 1, a tablet was prepared from the raw materials listed below to give a tablet having the formulation shown.

| | Raw | Tablet |
|---|---|---|
| | material | composition |
| | (g) | (wt %) |
| Na LAS as Example 1 | 30.20 | 52.66 |
| Nonionic surfactant C₁₃-C₁₅ 30EO | 5.96 | 10.39 |
| (Lutensol (Trade Mark) AO30 | | |
| ex BASF) | | |
| Sodium carbonate | 18.44 | 32.15 |
| PEG 6000 | 2.75 | 4.80 |
| Total | 57.35 | 100.00 |

Detergency

The detergency of the tablet of Example 2 was measured by a washing machine method using cotton and knitted polyester on the following soils: kitchen grease (soya bean oil), dirty engine oil, and butter. The tablet gave a robust performance across a wide range of water hardnesses (5, 20, 35 and 50 degrees French hard).

1. A solid porous surfactant body comprising at least 60 wt % surfactant and having a density not exceeding 700 g/litre.

2. A solid porous surfactant body as claimed in claim 1, comprising at least 75 wt % surfactant.

3. A solid porous surfactant body as claimed in claim 2, comprising at least 90 wt % surfactant.

4. A solid porous surfactant body as claimed in claim 1, having a density not exceeding 600 g/litre.

5. A solid porous surfactant body as claimed in claim 1, comprising at least 50 wt % of anionic sulphonate and/or sulphate surfactant.

6. A solid porous surfactant body as claimed in claim 1, comprising at least 70 wt % of anionic sulphonate and/or sulphate surfactant.

7. A solid porous surfactant body as claimed in claim 6, wherein the anionic surfactant comprises alkylbenzene sulphonate and/or alkyl sulphate.

8. A solid porous surfactant body as claimed in claim 1, which further comprises an ethoxylated alcohol nonionic surfactant of the general formula I
R—(—O—CH₂—CH₂)ₙ—OH (I)
wherein R is a hydrocarbyl chain having from 8 to 16 carbon atoms, and the average degree of ethoxylation n is from 20 to 50.

9. A solid porous surfactant body as claimed in claim 8, wherein the ethoxylated alcohol nonionic surfactant has a hydrocarbyl chain containing from 10 to 16 carbon atoms and an average degree of ethoxylation n of from 25 to 40.

10. A solid porous surfactant body as claimed in claim 1, which contains from 1 to 20 wt %, preferably from 5 to 15 wt %, of the ethoxylated nonionic surfactant.

11. A solid porous surfactant body as claimed in claim 1, wherein the surfactant comprises anionic surfactant and ethoxylated nonionic surfactant in a ratio of from 1:1 to 15:1, preferably from 1:1 to 10:1, more preferably from 2:1 to 6:1.

12. A solid porous surfactant body as claimed in claim 1, which contains not more than 40 wt %, preferably not more than 20 wt %, more preferably not more than 10 wt %, of inorganic salts.

13. A solid porous surfactant body as claimed in claim 12, which is substantially free of inorganic salts other than bleaching salts.

14. A solid porous surfactant body as claimed in claim 1, in the form of an assembly of particles of particle size greater than 1 micron and not exceeding 1500 microns.

15. A solid porous surfactant body as claimed in claim 14, wherein the particle size is within the range of from 200 to 1000 microns.

16. A solid porous surfactant body as claimed in claim 14, wherein the particles are of irregular shape.

17. A solid porous surfactant body as claimed in claim 14, wherein the particles are flakes.

18. A solid porous surfactant body as claimed in claim 1, which contains from 0.1 to 15 wt % binder.

19. A solid porous surfactant body as claimed in claim 18, wherein the binder comprises polyethylene glycol.

20. A process for the preparation of a solid porous surfactant body as claimed in claim 1, which comprises the steps of
(i) converting an assembly of surfactant particles to a cohesive state by heating and/or mixing with binder,
(ii) allowing the resulting cohesive assembly of particles to set to form a solid body.

21. A particulate detergent composition comprising a solid porous surfactant body as claimed in claim 1, in a mixture or conjunction with one or more other solid detergent ingredients.
